(19) United States
(12) Patent Application Publication
(10) Pub. No.: US 2002/0079067 A1
(43) Pub. Date: Jun. 27, 2002

(54) Horizontal mount for a headrail of a window covering

(76) Inventors: Michael J. McCarty, Mission Viejo, CA (US); John Elsenheimer, Yorba Linda, CA (US)

Correspondence Address: Kit M. Stetina, STETINA BRUNDA GARRED & BRUCKER, Suite 250, 75 Enterprise, Aliso Viejo, CA, 92656, US

(21) Appl. No.: 10/004,371

(22) Filed: Nov. 1, 2001

Related U.S. Application Data
(63) Continuation of application No. 09/669,006, filed on Sep. 25, 2000, now abandoned.

(51) Int. Cl. E06B 9/30

(52) U.S. Cl. 160/178.1 R

(57) ABSTRACT

A horizontal mount for retaining a headrail of a window covering within a recessed window frame. The mount includes an elongate, generally U-shape structure having two opposing generally parallel forward and rearward arms and a generally flat arm-connecting member, with the latter positionable against the top horizontal frame site of the recessed window frame such that the U-shape is inverted. Each arm is outwardly spring biased from the other arm and has a structured retainment portion for exteriorly accepting and tensionally retaining opposing elongate distal ends of the headrail. In a preferred embodiment, the structured retainment portion is an external inwardly directed lip-bordered channel of each length of arm within which opposing rolled walls of the headrail reside and are retained by spring tension such that no portion of the mount resides between the rolled walls. In this manner, both hand engagement and hand disengagement between the headrail and mount can be accomplished because no portion of the headrail mount extends within the interior of the headrail and no resulting structural disassembly is required.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention relates in general to window covering mounts, and in particular to a horizontal mount for retaining within a window frame a top headrail of a window covering such that the headrail is retained by spring-biased friction fit without requiring a hooking engagement between the mount and headrail.

Various types of window coverings are available for placement within a window frame such that the coverings reside totally within the frame whether in a blocking or open configuration. A typical example of such window coverings are venetian blinds having a headrail from which conventionally-strung blind slats extend vertically and which are provided with draw strings for raising and lowering the slats and with slat angle adjusters for controlling light passage. Typical headrails extend the width of the blinds and have opposing front and rear upwardly-extending walls rolled over along their respective top expanses to form elongate opposing internal hooks. Usual headrail mounts perform as cooperating hooks placed within the window frame along the top thereof to extend downwardly and engage the opposing hooks of the headrail. Some such mounts include two or more separate and spaced pieces that require relatively precise depth measurement for placement within the window frame, while other mounts may include single-piece construction with inner engagement of the headrail elongate opposing hooks and resulting difficulty in any subsequent headrail removal.

In view of the above-defined prior art window covering mounting approaches, it is apparent that a need is present for a headrail mount that is accurately installable without excessive measurement, and that safely retains a mounted headrail while yet allowing relatively non-complicated removability when dismounting is required. Accordingly, a primary object of the present invention is to provide an elongate window cover headrail mount readily alignable with an inside border of a window frame for correct placement with very little or no measurement.

Another object of the present invention is to provide an elongate window cover headrail mount capable of retaining a headrail therewith without internally entering the headrail for headrail-hook engagement.

Yet another object of the present invention is to provide an elongate window cover headrail mount wherein spring biasing accomplishes a friction-fit retainment which can be readily overcome by hand to accomplish direct dismounting of the headrail when so desired without tools or disassembly.

These and other objects of the present invention will become apparent throughout the description thereof which now follows.

### BRIEF SUMMARY OF THE INVENTION

The present invention is a horizontal mount for retaining a headrail of a window covering within a recessed window frame. The mount comprises an elongate, generally U-shape structure having two opposing generally parallel forward and rearward arms and a generally flat arm-connecting member, with the latter positionable against the top horizontal frame site of the recessed window frame such that the U-shape is inverted. Each arm is outwardly spring biased from the other arm and has a structured retainment portion for exteriorly accepting and tensionally retaining opposing elongate distal ends of the headrail. In a preferred embodiment, the structured retainment portion is an external inwardly directed lip-bordered channel of each arm within which opposing rolled walls of the headrail reside and are retained by spring tension such that no portion of the mount resides between the rolled walls. In this manner, both hand engagement and hand disengagement between the headrail and mount can be accomplished because no portion of the headrail mount extends as a hook within the interior of the headrail and no resulting structural disassembly is required.

### BRIEF DESCRIPTION OF THE DRAWINGS

An illustrative and presently preferred embodiment of the invention is shown in the accompanying drawings in which:

FIG. 1 is a front elevation view of a recessed window frame having positioned therein a venetian blind having a headrail retained by a horizontal mount;

FIG. 2 is a perspective view of the mount of FIG. 1; and

FIG. 3 is a perspective view, partially broken, of the mount of FIG. 2 with exemplified headrail there retained.

### DETAILED DESCRIPTION OF THE INVENTION

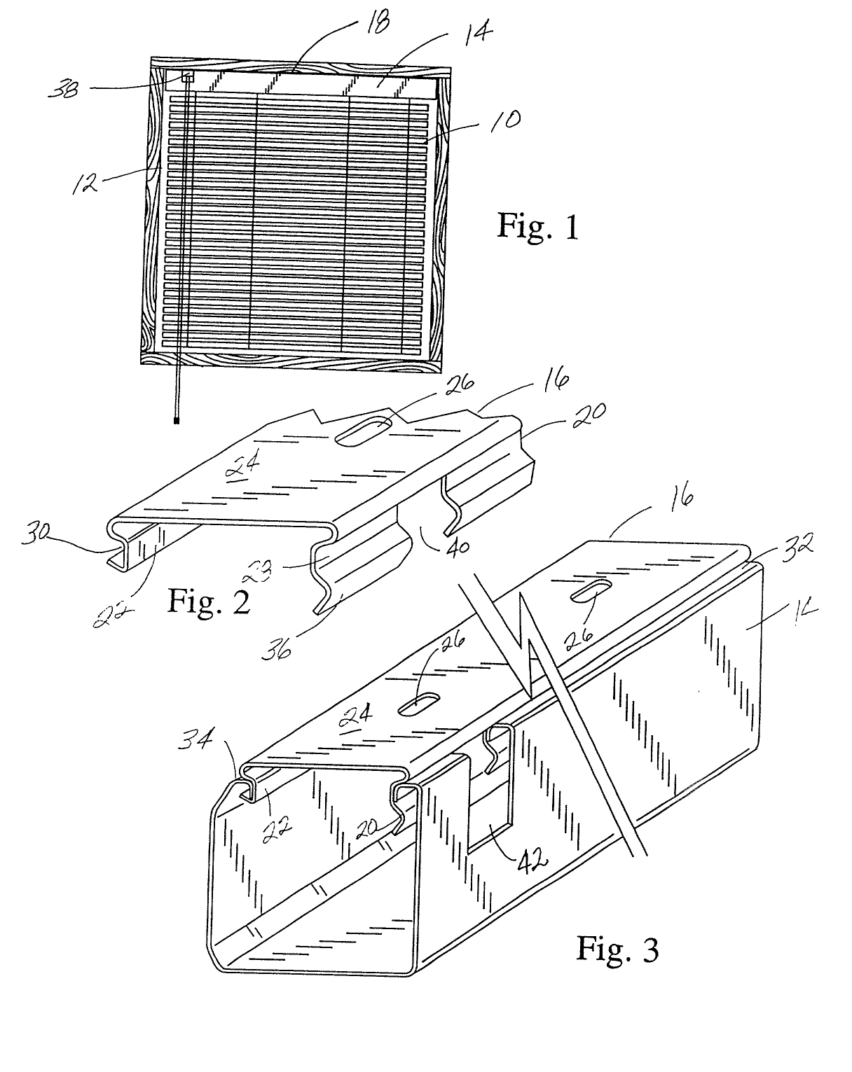

Referring to FIGS. 1-3, a window covering here exemplified as a venetian blind 10 is mounted within a recessed window frame 12. The blind 10 has a headrail 14 situated across its top for retaining engagement with a horizontal mount 16 attached along the recessed top 18 of the window frame 12. As clearly shown in FIGS. 2 and 3, the mount 16 is generally U-shape and has two opposing generally parallel forward and rearward arms 20, 22 and a generally flat arm-connecting member 24 having a plurality of apertures 26 through which respective fasteners such as screws (not shown) can be inserted for attachment of the mount 16 to the horizontal top 18 within the window frame 12. The arms 20, 22 are outwardly spring-biased from each other, and preferably are so sprung due to inherent characteristics of the metal (e.g. spring steel) used to fabricate the mount 16. Each arm 20, 22 has an external, inwardly-directed, respective lip-bordered forward and rearward channels 28, 30 operational as structured retainment portions for exteriorly accepting and tensionally retaining opposing elongate distal ends 32, 34 of the headrail 14. At least one arm 20 has a guide ramp 36 leading to the channel 28 for guiding at least one distal end 32 of the headrail 14 into the channel 28 as the window covering is secured within the window frame 12. To accommodate an operator mechanism 38 such as a draw cord of the venetian blind 10, both the mount 16 and headrail 14 are provided with respective cut-out void portions 40, 42 that align with each other when the headrail 14 is secured with the mount 16.

In operation, the mount 16 is first attached to the horizontal top 18 within the window frame 12 using conventional screws placed through the apertures 26 as described above. Thereafter, the headrail 14, with venetian blind 10 attached thereto, is introduced to the mount 16 by first placing the rearward elongate distal end 32 into the rear channel 28 of the rearward arm 22, and thereafter sliding the forward elongate distal end 34 on the guide ramp 36 to be captured within the forward channel 30 of the forward arm 20. Because of the outward spring biasing of the arms 20, 22, the elongate distal ends 32, 34 of the headrail 14 are securely retained, yet are removable by hand upon inward pressure on the mount 14.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A horizontal mount for retaining a headrail of a window covering within a recessed window frame, the mount comprising an elongate, generally U-shape structure having two opposing generally parallel forward and rearward arms and a generally flat arm-connecting member, wherein each said arm is outwardly spring biased from the other arm and has a structured retainment portion for exteriorly accepting and tensionally retaining opposing elongate distal ends of the headrail.

2. A horizontal mount as claimed in claim 1 wherein the arm-connecting member additionally comprises an attachment receiver for receiving a fastener for retaining the arm-connecting member against a recessed horizontal frame site of the recessed window frame.

3. A horizontal mount as claimed in claim 2 wherein the attachment receiver comprises a plurality of apertures through which respective screws can be inserted for subsequent engagement with the recessed horizontal frame site.

4. A horizontal mount as claimed in claim 1 wherein at least one arm thereof has a cut-out void portion for accommodating protruding window-covering operator mechanisms.

5. A horizontal mount as claimed in claim 1 wherein the structured retainment portion is an external inwardly directed lip-bordered channel of each arm.

6. A horizontal mount as claimed in claim 5 wherein the lip-bordered channel of at least one arm has a guide ramp leading thereto for guiding the opposing elongate distal ends of the headrail when said ends are in contact with said ramp.

7. A horizontal mount as claimed in claim 1 wherein the structured retainment portion of at least one arm has a guide ramp leading thereto for guiding the opposing elongate distal ends of the headrail when said ends are in contact with said ramp.
